(19) United States
(12) Patent Application Publication
(10) Pub. No.: US 2023/0090766 A1
(43) Pub. Date: Mar. 23, 2023

(54) On-Demand Enabling of Functional Entities in Cellular Modem for Power Saving

(71) Applicant: Apple Inc., Cupertino, CA (US)

(72) Inventors: Thorsten CLEVORN, Munchen (DE); Stefan MEYER, Hoechstadt (DE)

(21) Appl. No.: 17/448,433

(22) Filed: Sep. 22, 2021

(51) Int. Cl. H04W 36/36; H04W 48/16; H04W 72/04; H04W 36/06; H04W 48/04

(52) U.S. Cl. CPC H04W 36/36; H04W 48/16; H04W 72/048; H04W 36/06; H04W 48/04

(57) ABSTRACT

A user equipment (UE) is configured to power on a primary module of a cellular modem to perform signal processing operations for the UE, the primary module having first signal processing capabilities, detect an occurrence of an event, wherein the event indicates a change in network operations to be performed by the UE, determine event information indicating whether the change in network operations may use more signal processing capabilities than the primary module is able to perform, determine, based on the event information, a power state to be used for a secondary module of the cellular modem, wherein secondary module has second signal processing capabilities and is configured to perform further signal processing operations for the UE, and change a current power state for the secondary module when the determined power state is different from the current power state.

### BACKGROUND

A user equipment (UE) may establish a connection to at least one of multiple different networks or types of networks via a cellular modem. The different networks, or network types, may provide different network services to the UE. For example, one network deployment may allow for fewer aggregated carriers for communications with the UE than a different network deployment. A given network deployment, e.g., having a maximum of two aggregated carriers, may require less signal processing by the modem than a more complicated network deployment, e.g., having a maximum of six aggregated carriers.

The cellular modem of a UE may be dimensioned for a higher signal processing capacity, e.g., throughput, than is typically required for network operations. For example, the modem may be dimensioned for maximum expected network operations, even though the UE typically performs less intensive network operations during a majority of its life. Parts of the modem may remain in a standby state until an increased signal processing capacity is needed and these parts are fully powered on. However, the cumulative power usage for these modem parts, remaining in the standby state over a long duration, may be significant.

### SUMMARY

Some exemplary embodiments are related to a processor of a user equipment (UE) configured to perform operations. The operations include powering on a primary module of a cellular modem to perform signal processing operations for the UE, the primary module having first signal processing capabilities, detecting an occurrence of an event, wherein the event indicates a change in network operations to be performed by the UE, determining event information indicating whether the change in network operations may use more signal processing capabilities than the primary module is able to perform, determining, based on the event information, a power state to be used for a secondary module of the cellular modem, wherein secondary module has second signal processing capabilities and is configured to perform further signal processing operations for the UE, wherein the power state comprises a fully powered off state, a standby state, or a fully powered on state and changing a current power state for the secondary module when the determined power state is different from the current power state.

Other exemplary embodiments are related to a user equipment (UE) having a transceiver configured to communicate with a network and a processor communicatively coupled to the transceiver and configured to perform operations. The operations include powering on a primary module of a cellular modem to perform signal processing operations for the UE, the primary module having first signal processing capabilities, detecting an occurrence of an event, wherein the event indicates a change in network operations to be performed by the UE, determining event information indicating whether the change in network operations may use more signal processing capabilities than the primary module is able to perform, determining, based on the event information, a power state to be used for a secondary module of the cellular modem, wherein secondary module has second signal processing capabilities and is configured to perform further signal processing operations for the UE, wherein the power state comprises a fully powered off state, a standby state, or a fully powered on state and changing a current power state for the secondary module when the determined power state is different from the current power state.

Still further exemplary embodiments are related to a processor of a user equipment (UE) configured to perform operations. The operations include powering on a first part of a cellular modem to perform signal processing operations for the UE, the first part having first signal processing capabilities, detecting an occurrence of an event, wherein the event indicates an increase in total network operations to be performed by the UE, powering on a second part of the cellular modem to perform channel measurement functions, the second part having second signal processing capabilities, wherein the first and second signal processing capabilities of the first and second parts are insufficient for performing the increased total network operations to be performed by the UE, and initiating a powering-on of a third part of the cellular modem having third signal processing capabilities, wherein the first, second and third signal processing capabilities of the first, second and third parts are sufficient for performing the increased total network operations to be performed by the UE, wherein the second part performs the channel measurement functions during the powering-on of the third part.

Additional exemplary embodiments are related to a user equipment (UE) having a transceiver configured to communicate with a network and a processor communicatively coupled to the transceiver and configured to perform operations. The operations include powering on a first part of a cellular modem to perform signal processing operations for the UE, the first part having first signal processing capabilities, detecting an occurrence of an event, wherein the event indicates an increase in total network operations to be performed by the UE, powering on a second part of the cellular modem to perform channel measurement functions, the second part having second signal processing capabilities, wherein the first and second signal processing capabilities of the first and second parts are insufficient for performing the increased total network operations to be performed by the UE, initiating a powering-on of a third part of the cellular modem having third signal processing capabilities, wherein the first, second and third signal processing capabilities of the first, second and third parts are sufficient for performing the increased total network operations to be performed by the UE, wherein the second part performs the channel measurement functions during the powering-on of the third part.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary processor of a user equipment (UE) including a two-part modem according to various exemplary embodiments.

FIG. 4 shows a flowchart for changing a power state of a secondary module in a modem architecture comprising a primary module and a secondary module.

FIG. 5 shows an exemplary diagram for a modem power state change based on a detected SIM activation/change according to various exemplary embodiments.

FIG. 6 shows an exemplary diagram for a modem power state change based on a detected tracking area (TA) change according to various exemplary embodiments.

FIG. 7 shows an exemplary database structure for determining a modem power state change according to various exemplary embodiments.

FIG. 8 shows a flowchart for database updates according to various exemplary embodiments.

FIG. 9a shows a flowchart for carrier activation handling using a multi-part modem architecture according to various exemplary embodiments described herein.

FIG. 9b shows an exemplary diagram for carrier activation handling and an associated modem power consumption graph as a function of time.

### DETAILED DESCRIPTION

The exemplary embodiments may be further understood with reference to the following description and the related appended drawings, wherein like elements are provided with the same reference numerals. The exemplary embodiments relate to a cellular modem architecture comprising multiple parts, for example a primary module and a secondary module. The primary module may be configured for performing certain network operations that use less signal processing capacity than is attainable by the entire modem, and may be powered on during all network operations. The secondary module may be configured for performing further network operations that use an increased processing capacity than those attainable by the primary module. The secondary module may be powered on only when the UE determines that the increased capabilities provided by the secondary module are used or may be used. For example, the secondary module may be powered on to a standby state, powered on fully, powered down to the standby state, powered off fully, or kept in a current power state, when certain events are detected by the UE.

Various events may trigger the UE to evaluate whether a state change should be performed for the secondary module of the modem. For example, in some exemplary embodiments, the activation of a subscriber identity module (SIM) may trigger a UE evaluation with respect to the power state of the secondary module. The state change evaluation may be performed during an initial cell search and registration with a particular network operator, e.g., public land mobile network (PLMN), or may be performed after initial registration with the PLMN. Based on the network arrangement deployed by the operator, e.g., the frequency bands and carriers used by the PLMN, the UE may determine whether the secondary module should be activated (into standby, or fully powered on), powered off, or kept in its current state.

In another example, in a mobility scenario, the UE may select a new PLMN and/or tracking area (TA) having different maximum network capabilities than the previous PLMN/TA. When the new PLMN/TA is selected, the UE may determine whether the current state of the secondary module should be changed based on the new network capabilities.

In other exemplary embodiments, the modem architecture comprises a split of greater than two parts. For example, a first part of the modem may be enabled for an initial RRC configuration, e.g., comprising N carriers. When a new carrier, in addition to the N initial carriers, is added in an RRC reconfiguration, a second part of the modem may be enabled for performing measurements on the new carrier and transmitting measurement reports to the network. A third part of the modem may be enabled in parallel with or after the second part, and may perform Physical Downlink Control Channel (PDCCH)/Physical Downlink Shared Channel (PDSCH) decoding once fully powered.

### Network/Devices

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component.

The exemplary embodiments are also described with regard to a 5G New Radio (NR) network. However, reference to a 5G NR network is merely provided for illustrative purposes. The exemplary embodiments may be utilized with any network, as will be described in detail below. For example, in some embodiments, a legacy network may be selected by the UE that causes the UE to evaluate whether a state change should be implemented for the secondary module. Therefore, the 5G NR network as described herein may represent any type of network.

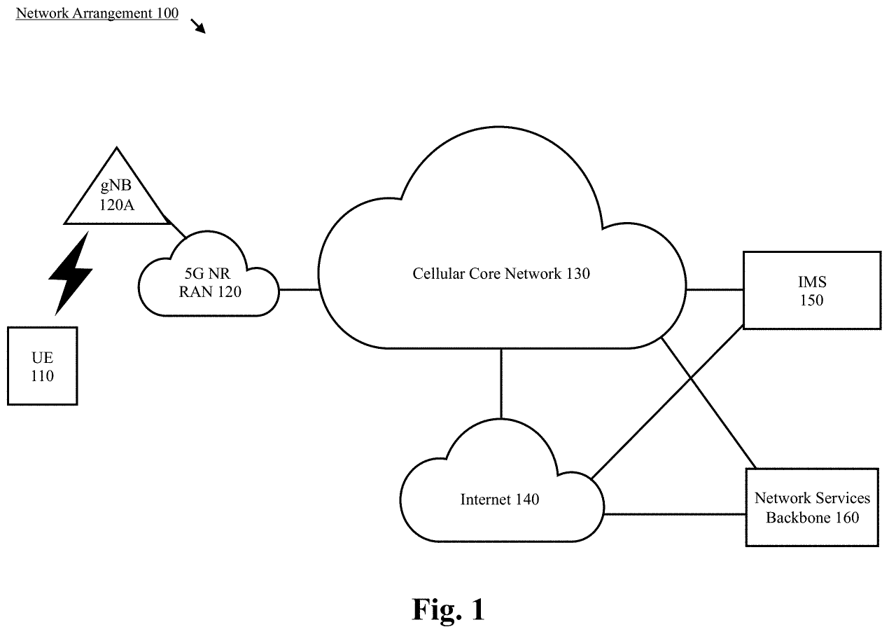

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120 and a subscriber identification module (SIM) including identifying information for one or more public land mobile networks (PLMN) to which the UE may connect. The PLMN(s) may provide access to one or more networks, including the 5G NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In network arrangement 100, the 5G NR RAN 120 includes a base station (e.g., gNB 120A) that represents a gNB deployed by a PLMN. The gNB 120A may include one or more communications interfaces to exchange data and/or information with UEs, the corresponding RAN, the cellular core network 130, the internet 140, etc. The gNB 120A may include a processing arrangement configured to perform various operations for providing network connectivity to the UE 110. However, reference to a processor is merely for illustrative purposes. The operations of the gNB 120A may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some examples, the functionality of the processor is split among two or more processors such as a baseband processor and an applications processor. The exemplary embodiments may be implemented in any of these or other configurations of a cell.

The UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider, e.g., PLMN, where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific cell (e.g., the gNB 120A). However, as mentioned above, reference to the 5G NR-RAN 120 is merely for illustrative purposes and any appropriate type of RAN may be used.

In addition to the 5G NR RAN 120, the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

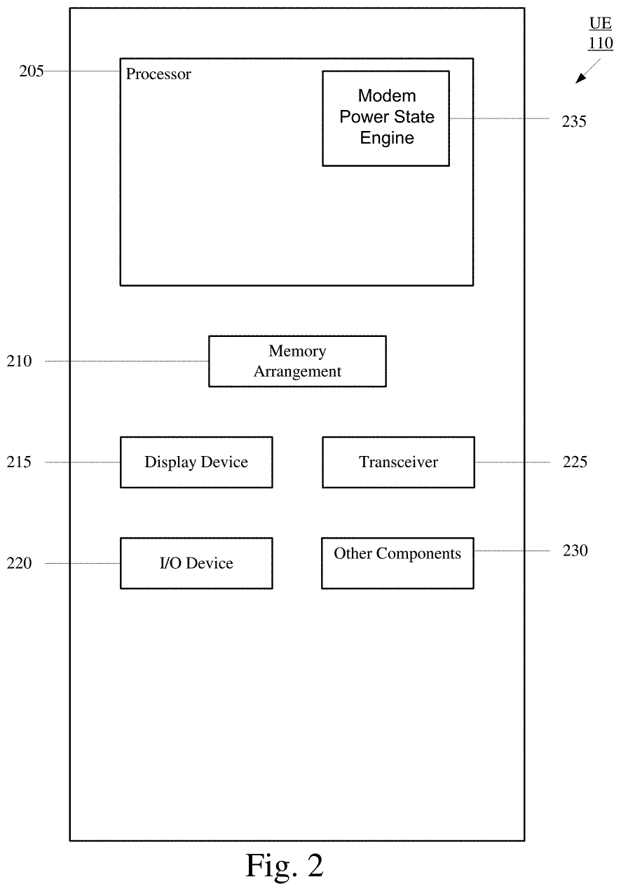

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a modem power state engine 235. The modem power state engine 235 may be configured to perform operations for determining whether a current power state of a secondary module of the modem should be changed. For example, the power state of the secondary module may comprise a fully powered off state, a standby state, or a fully powered on state, etc. The UE 110 may determine to change the state of the secondary module based on detected events that indicate that increased or decreased processing capacity is or may be used by the modem. In other exemplary embodiments, the modem power state engine 235 may coordinate the activation of additional functional entities of the modem. For example, a first part of the modem may be activated for processing a number of carriers, e.g., according to the maximum capabilities of the first part, while a second part is activated for performing initial measurements on a newly added carrier and a third part is activated for performing PDCCH/PDSCH decoding on the newly added carrier. These trigger events and associated operations will be described in further detail below.

The above referenced engine being an application (e.g., a program) executed by the processor 205 is only exemplary. The functionality associated with the engine may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

### Cellular Modem Architecture

A cellular modem may provide cellular network access to a user equipment (UE). Some cellular modems may be over-dimensioned in terms of capabilities, e.g., throughput, attainable by the modem. For example, in a majority of use cases, as little as 10% of the modem throughput may be used to perform network operations at a given time.

In a monolithic modem, existing operations may be used to reduce the power consumption of the modem. For example, the modem may comprise multiple power domains that are clock gated so that one or more of the power domains are in a lower power standby state until increased processing power is used. However, these power domains that are not currently being used for signal processing are not powered off completely because they should be available quickly, e.g., within milliseconds, if they are to be used. Thus, the parts of the modem in standby still consume a considerable amount of power, particularly over long durations. However, at any given moment, there is a low probability that the parts of the modem in standby will be used.

A modem architecture comprising multiple parts, e.g., a primary module and a secondary module, may have many benefits. For example, the secondary module may be powered off, or transitioned into a lower power mode, when not being used, e.g., most of the time). This may be done more easily than in a monolithic modem.

According to various exemplary embodiments described herein, a modem architecture is described in which a primary module, dimensioned with first signal processing capabilities, is used for a first subset of network operations and a secondary module, dimensioned with second signal processing capabilities, is used for a second subset of network operations. In the following description, the first module is described as being dimensioned to have less capabilities than the secondary module. However, an architecture where the primary module has equal or greater capabilities than the second module may also be used. As used herein, “capabilities” generally relates to the performance of the modem/module with respect to the maximum throughput, e.g., rate of processing work, attainable by the modem/module. The capabilities may be described with respect to a maximum number of carriers in a carrier aggregation (CA) deployment, a maximum aggregated bandwidth, a maximum number of multiple-input multiple-output (MIMO) layers, etc., able to be handled by the modem/module. Thus, the term “capabilities” may relate to any number of metrics pertaining to the processing capacity of the modem or modules/parts of the modem.

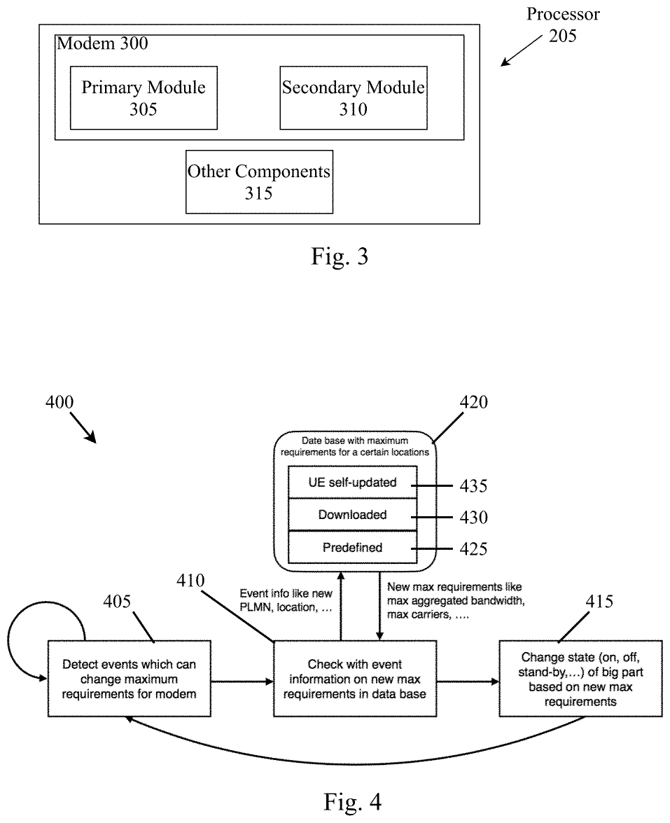

FIG. 3 shows an exemplary processor 205 of a user equipment (UE) 110 including a two-part modem 300 according to various exemplary embodiments. The modem 300 comprises a primary module 305 and a secondary module 310, each configured to perform signal processing operations for network communications, to be described in detail below. The processor 205 further includes other components 315 such as a central processing unit (CPU), a graphics processing unit (GPU), etc., for implementing the UE functionalities discussed above. The processor 205 may comprise multiple cores, each configured to perform processing operations for the UE 110. Each core may operate separately from the other cores, or multiple cores may perform operations in parallel on a shared set of data.

The architecture of the modem 300 is designed so that the primary module 305 and the secondary module 310 may be powered up, powered down, or transitioned into a standby state independently. As described herein, there are three power modes for the secondary module. However, those skilled in the art will understand that there may be more power modes and how to extend the exemplary embodiments to any additional power modes based on the following description. The primary module 305 may be powered on during all network operations, while the secondary module 310 may be powered on only under certain conditions and operate in parallel with the primary module 305. Thus, when only the primary module 305 is powered on, only part of the full modem capabilities are deployed. For example, the bandwidth available to the modem 300 using only the primary module 305 may be approximately 120 MHz in a 2×2 MIMO scenario, while the bandwidth available to the modem 300 using both the primary and secondary modules 305, 310 may be approximately 360 MHz in a 2×2 MIMO scenario.

In the exemplary embodiments, the primary module 305 comprises less signal processing capacity than the secondary module 310 because only a small amount of the total modem capabilities are used for a large proportion of the network operations performed by the modem 300. Thus, the primary module 305 is dimensioned for performing certain network operations that use only a small amount of capabilities relative to the secondary module 310, which is dimensioned for performing network operations that require significantly greater capabilities. However, the relative capabilities of the primary module 305 and the secondary module 310 may be configured differently, depending on different requirements for a wide range of UEs having different capabilities.

The primary module 305 may control the operations performed by the secondary module 310, including initiating a power state change for the secondary module 310 from a powered off state, a standby state, or a fully powered on state to another one of the states. Alternatively, this functionality may be implemented via another aspect of the processor 205. Thus, the modem power state engine 235 described above may be configured at the primary module 305 or separately from the primary module 305. The modem 300 may comprise one or more processing cores, for example a first core including the primary module 305 and a second core including the secondary module 310. Alternatively, the functionalities of the primary and secondary modules 305, 310 may be included on a single core or spread amongst more than two cores. The primary module 305 may be a separate component, or may be part of a same component as the secondary module 310, wherein the two parts are logically separated in one or more of the ways discussed above (separate cores, separate units within a core, etc.).

In other exemplary embodiments to be described below, more than two parts/modules may be used in the modem architecture. For example, a first part may be used for up to a certain number N of configured carriers. When an additional carrier is added, a second part may be enabled for performing measurements while a third part (e.g., that may have greater capabilities than the second part) may be booted for performing PDCCH/PDSCH decoding when the additional carrier is used by the network. These exemplary parts may be chained together in such a way that the first part activates the second part, the second part activates the third part, etc. In another embodiment, the first part may activate both the second and third parts in parallel. Although three parts are described, additional parts may be used in the exemplary modem architecture.

The term “module” or “part,” as used herein, generally refers to a portion of a processing arrangement for a device, wherein each module/part may be powered up or powered down (or put into standby) separately from the other modules/parts. The modules/parts as described herein are aspects of a cellular modem, wherein each module/part has circuitry for performing signal processing operations for communications with a cellular network. The primary module may be used in scenarios in which only some of the total modem capabilities are used for performing the network operations. The primary module/part may be powered on at all times in which the UE is communicating or attempting to communicate with a network. The secondary module (and/or additional modules/parts) may be powered on only when it is determined that increased capabilities are being used or may be used. The primary module may activate the further modules when certain trigger conditions are met.

### Power State Change for Secondary Module in Two-Part Modem Architecture

According to one aspect of the present disclosure, various events may trigger the powering-on or powering-off of the secondary module. The primary module may remain powered on at all times the modem is performing signal processing operations (at least in a standby state, when the UE is e.g., in idle mode, or in the fully powered state, when the UE is e.g., in connected mode). The primary module may receive/determine information regarding these trigger events and initiate the power-up or power-down of the secondary module accordingly. The secondary module may be fully powered off, put in the standby state or fully powered up depending on commands from the primary module or from other aspects of the processing arrangement.

Examples of events triggering the power state evaluation for the secondary module include a SIM card activation/change, a PLMN/tracking area change, and an anticipated RRC reconfiguration and/or carrier activation. However, other events may also trigger the power state evaluation for the secondary module. In case of such an event, the new capabilities that are to be used, or potentially may be used, for the new network deployment after the event are evaluated, and the power state of the secondary module is changed, if needed.

For the evaluation, the UE may use a database with the potential maximum expected network capabilities for various UE deployment scenarios. These maximum network capabilities may be compared to the capabilities of the modem, e.g., the capabilities (e.g., maximum throughput) of the primary module and the secondary module, to determine whether the secondary module should be powered on, powered down, or kept in a current power state. The database may be predefined (e.g., by the phone vendor), downloaded (e.g., externally updated by the vendor or an operator), and/or internally updated by the UE itself, based on observations made by the UE. The database may also comprise different levels of granularity. For example, a more detailed version of a database, relative to a previously stored database, may be downloaded by the UE when the UE, e.g., changes location.

FIG. 4 shows a flowchart 400 for changing a power state of a secondary module in a modem architecture comprising a primary module and a secondary module. Each of the aspects of the flowchart 400 will be described in greater detail below.

In 405, an event is detected that may change the maximum required capabilities for the cellular modem. For example, as discussed above, a SIM change/activation, a PLMN/TA change, or an anticipated RRC reconfiguration may be detected.

Once detected, event information is determined. The event information may comprise, for example, a public land mobile network (PLMN) ID for the PLMN with which the UE is registered, a tracking area (TA) code (TAC) for a TA within the PLMN, and/or a particular location/cell where the UE is camped.

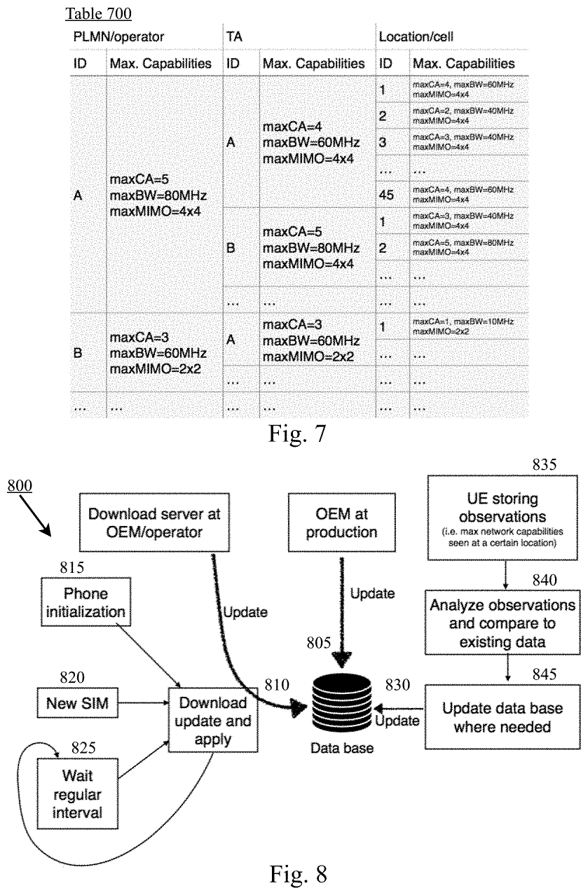

In 410, the database 420 is checked against the event information. The database 420 may include the expected maximum capabilities of various network deployments, e.g., a maximum number of aggregated carriers (CA), a maximum bandwidth, or a maximum number of MIMO layers that may be used by a particular PLMN, in a particular TA or on a particular cell. The structure of the database will be described below with respect to FIG. 7.

The database 420 may comprise predefined values 425, e.g., values that are stored to the UE when the UE is manufactured. The database 420 may also comprise updated values that were, e.g., downloaded by the UE (430) or self-updated by the UE (435). For example, in the case of self-updates, the expected maximum capabilities of the network deployment may be determined based on observations by the UE and updated relative to previously stored values.

In 415, based on the information in the database 420, the state of the secondary module of the modem may be updated. For example, the secondary module may be powered up fully (from the off state or the standby state), powered up into standby (from the off state), powered down into standby (from the on state), powered down fully (from the on state or the standby state), or kept in a current state.

### SIM Change Event and PLMN/TA Change Event

A SIM event may occur when the user of the UE is changing the SIM of the UE (e.g., manually) or switching between SIMs in a dual-SIM capable UE. After the SIM change, no data transfer is expected immediately. For example, the timescale between the SIM change and expected data transfer is on the order of seconds. When the new SIM is activated, the UE performs a cell search and a new registration with a PLMN matching a PLMN ID stored on the new SIM. For this cell search, the primary module may be sufficient. However, the UE may determine, during the search/registration process, whether enhanced modem capabilities may be used once the UE is registered and has selected a cell to camp on.

The database may include maximum network capabilities for a given PLMN, and thus, even before the UE registers with the PLMN, the UE may determine based on the SIM credentials whether increased modem capabilities may be used. When the UE is selecting a cell to camp on, a PLMN associated with credentials in the SIM is selected. Based on the selected PLMN, and the tracking area (TA) associated with the selected cell, the UE may again check the database, this time determining which bands and carriers are available in the network deployment of the PLMN/TA. Based on this knowledge, the UE may then determine whether the secondary module is (or may be) needed for handling the signal processing for the network deployment. It is noted that a partial enabling of the secondary module is also possible, for example when certain features (e.g., FR2) are not enabled in the PLMN.

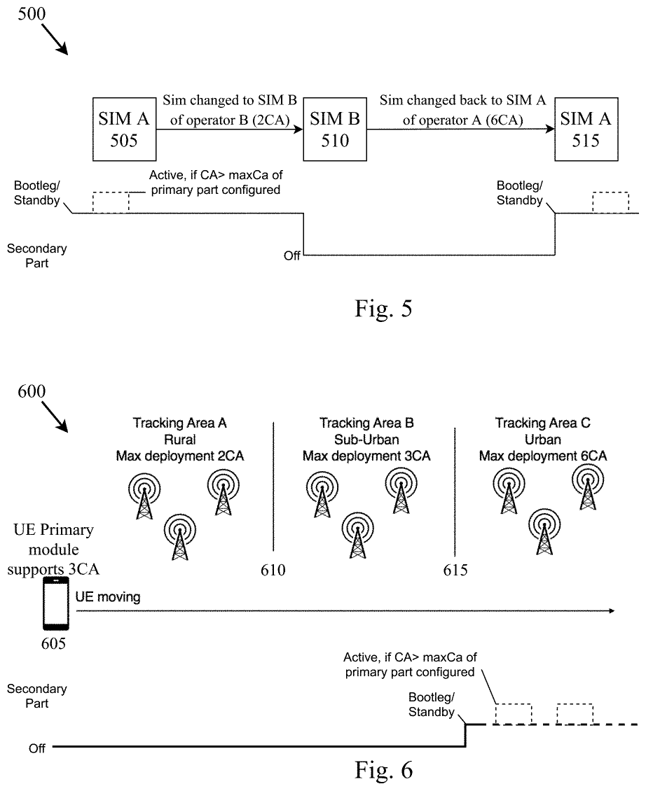

FIG. 5 shows an exemplary diagram 500 for a modem power state change based on a detected SIM activation/change according to various exemplary embodiments. In the example of FIG. 5, the capabilities of the primary and secondary modules of the modem are defined with respect to a total number of carriers supported in a carrier aggregation (CA) deployment. In this example, the primary module supports three aggregated carriers (3CA) and the secondary module supports greater than 3CA, e.g., 9CA. Thus, in this example, the total modem capability when both modules are powered is 12CA. The UE, in this example, is a single SIM UE wherein a user manually switches SIMs. However, the UE may also be a dual-SIM UE having credential information for operator A on SIM A and for operator B on SIM B. The following example may relate to a dual-SIM UE wherein only one of the two SIMs may be active at one time. However, the person skilled in the art would understand that the exemplary process may be modified for scenarios where both SIMs are activated in parallel, e.g., dual-active and dual-standby scenarios, depending on the requirements imposed on the modem for these scenarios.

In 505, the UE activates SIM A and initially registers with operator A (e.g., PLMN A) using SIM A. The new registration to PLMN A uses only limited modem capabilities, thus the primary module of the modem is sufficient. However, the UE may perform, in parallel with the new registration, an evaluation regarding whether the PLMN may use enhanced modem capabilities. During the new registration, a PLMN identifier (ID) and a tracking area code (TAC) may be determined from information broadcast by a network cell. Based on the PLMN/TA, the UE may determine whether the secondary module should be activated.

When a cell operated by PLMN A is selected, the UE is provided with the PLMN ID and the TAC of the cell. Using this information, the UE checks the database for the maximum CA deployment for the PLMN/TA. Depending on the granularity of the database, only the operator/PLMN may be checked, or, if TA information is included in the database, the TA may be checked.

In this example, the maximum CA deployment of PLMN A is found in the database to be 6CA. Because PLMN A supports a greater number of carriers than the primary module of the UE supports, it may be determined that the secondary module may potentially be used.

Based on this determination, the secondary module is powered on to at least the standby mode. That is, even though PLMN A supports 6CA, fewer than 6CA may be initially configured for the UE. For example, if 3CA or less are initially configured for the UE, the secondary module may not be used and therefore may not be placed in the fully powered on state. However, due to the potential for additional carriers to be added, the secondary module may be placed into the standby mode so that the secondary module can be powered on fully when greater than 3CA are configured. If the initial configuration for the UE is greater than 3CA, then the secondary module may be fully powered on.

In 510, the UE changes SIMs and activates SIM B. Upon activation, the UE initially registers with operator B (e.g., PLMN B) using SIM B. The new registration to PLMN B may use only limited modem capabilities, thus the primary module of the modem may be sufficient. When the SIM is changed, the UE may automatically change the power state of the secondary module to the fully powered off state, pending the CA information to be determined for PLMN B. Alternatively, the secondary module may remain in a current state until the PLMN B is assessed.

When a cell operated by PLMN B is selected, the UE is provided with the PLMN ID and the TAC of the cell. Using this information, the UE checks the database for the maximum CA deployment for the PLMN/TA. Similar to above, depending on the granularity of the database, only the operator/PLMN may be checked, or, if TA information is included in the database, the TA may be checked.

In this example, the maximum CA deployment of PLMN B is found in the database to be 2CA. Because PLMN B supports an equal or lesser number of carriers than the primary module of the UE supports, it may be determined that the secondary module may not be used. Thus, the secondary module may be powered off completely (or kept in the fully powered off state), because there is no chance that the additional modem capacity provided by the secondary module will be used.

In 515, the UE again changes SIMs and activates SIM A. Similar to 505, the UE checks the database for the maximum CA deployment for the PLMN/TA. The maximum CA deployment of PLMN A is found in the database to be 6CA, and the secondary module is powered on to at least the standby mode, pending the actual CA configuration for the UE.

The example of FIG. 5 is described with respect to a number of carriers supported by each of the modem modules. However, a similar mechanism may be used that is based on maximum aggregated bandwidth supported by the modules, a maximum number of MIMO layers, or some other capability-related metric.

A second type of event, related to the SIM change event discussed above, is a PLMN/TA change. In this scenario, a similar process is used by the UE to determine whether the secondary module may be used, with only the initial cell search and registration described above (during SIM activation) being omitted. When a PLMN/TA is selected, a set of possible carrier aggregation scenarios, (aggregated) bandwidths, or RATs is determined from the exemplary database and thus the modem resources (e.g., secondary module of the modem) can be disabled/enabled in connected mode according to the network capabilities.

In a mobility scenario in connected mode, a new PLMN/TA may be selected, and the power state of the associated modem resource (secondary module) can be changed, e.g., enabled/disabled. A partial enabling of the secondary module (big part) may also be possible in case certain features (e.g., FR2) are not enabled in the PLMN. The assumed switching duration is in the order of several hundred ms. The UE can again use a database where the capabilities per operator, location, tracking area are listed.

FIG. 6 shows an exemplary diagram 600 for a modem power state change based on a detected tracking area (TA) change according to various exemplary embodiments. In the example of FIG. 6, the UE is registered to a PLMN and is moving across a plurality of tracking areas (TAs) for the PLMN, e.g., TA A, TA B and TA C. TA A is, for example, a rural deployment, wherein the maximum CA deployment is 2CA. TA B is, for example, a suburban deployment, wherein the maximum CA deployment is 3CA. TA C is, for example, an urban deployment, wherein the maximum CA deployment is 6CA. Similar to FIG. 5 discussed above, the capabilities of the primary and secondary modules of the modem are defined with respect to a total number of carriers supported in a CA deployment. In this example, the primary module supports three aggregated carriers (3CA), and the secondary module supports greater than 3CA, e.g., 9CA, so that the modem supports a total of 12CA.

In 605, the UE selects a cell in TA A. Based on the TAC of TA A, the UE checks the database and determines the maximum CA deployment to be 2CA. Based on this determination, the UE uses only the primary module of the modem, which has a processing capacity greater than 2CA. The secondary module is fully powered off.

In 610, the UE detects a new TA, e.g., TA B, in cell measurements performed in the connected state on TA A. Based on the TAC of TA B, the UE checks the database and determines the maximum CA deployment to be 3CA. Based on this determination, the UE uses only the primary module of the modem, which has a processing capacity equal to 3CA. The secondary module is fully powered off. The UE proceeds to select a cell in TA B and performs signal processing using only the primary module of the modem.

In 615, the UE detects another new TA, e.g., TA C, in cell measurements performed while in the connected state on TA B. Based on the TAC of TA C, the UE checks the database and determines the maximum CA deployment to be 6CA. Based on this determination, the UE may power the secondary module at least to the standby state, in case greater than 3CA are configured. If greater than 3CA are configured during initial cell selection on TA C, or at any point while connected on TA C, then the secondary module is fully powered on.

The process described above may be implemented in a similar manner for a PLMN change, e.g., transitioning from a first network deployed by the PLMN, such as a 5G NR network, to a second network deployed by the PLMN, such as an LTE network. The 5G NR network may have increased maximum capabilities relative to the LTE network, and the UE may, in some embodiments, power off the secondary module to perform network operations with the LTE network.

### Database

As mentioned above, the database consulted by the UE may comprise different levels of granularity. For example, instead of determining the power state of the secondary module based on the tracking area only, the determination may be made based on, e.g., location/cells. For example, when the UE changes location and/or detects new cell measurements, the UE may check the location/cell in database to determine if greater or fewer capabilities are used/possible.

FIG. 7 shows an exemplary database structure 700 for determining a modem power state change according to various exemplary embodiments. A first level of the database comprises a PLMN/operator and maximum modem capabilities associated with the PLMN. For example, PLMN A may have some associated maximum modem capabilities and PLMN B may have some other maximum modem capabilities. However, PLMN A and PLMN B are used only as examples, and any number of PLMN/operators may be defined in the database 700.

In this example, the maximum network capabilities are defined with respect to maximum CA support, maximum bandwidth support, and maximum MIMO support. However, these capabilities are merely provided as examples, and other types of capabilities for the network and/or the modem may be defined.

A second level of the database comprises a tracking area (TA) for the PLMNs. For example, TA A deployed by PLMN A, TA B deployed by PLMN A, TA A deployed by PLMN B, etc. may have respective maximum network capabilities associated therewith. Any number of TAs may be defined per PLMN. A third level of the database comprises a location/cell within the TAs. Similar to above, any number of locations/cells may be defined per TA.

The database may be stored and/or updated in one or more of the following exemplary manners. FIG. 8 shows a flowchart 800 for database updates according to various exemplary embodiments.

In some exemplary embodiments, when the UE is manufactured, a default database may be stored in the UE by the original equipment manufacturer (OEM), as shown in 805. The content of the default database, e.g., the maximum aggregated carriers, bandwidth, etc. to be expected for various network deployments, may be obtained by the OEM in one or more ways. For example, the default database content may be obtained from operators. In another example, the default database content may be obtained from devices already deployed by the OEM in the field (e.g., crowd-sourced data).

To limit the size of the database, not all hierarchy levels discussed above may be stored. For example, only the PLMN and TA, but not the individual location/cell information, may be stored. In another example, if the OEM knows in advance to which country a UE will be shipped, only database details relevant to PLMNs operating in that country may be included. Alternatively, limited details relevant to PLMNs in other countries may also be included.

Network deployments change over time, so the database may become outdated for one or more deployment scenarios. Thus, at certain points, e.g., at first device initialization by a customer (815), when a new SIM is inserted (820), or at regular intervals (825) (e.g., monthly), the UE may connect to a server to download an updated database, as shown in 810. This may also be provided at different detail levels, e.g., full details are provided for a current country of operation and fewer details are provided for other countries. The server and data may be provided by the operator or by the OEM. The OEM may obtain the updated data similarly to the default data, e.g., from the operator or by crowd-sourced data collection of devices deployed by the OEM.

Different database sets may be provided to different UEs based on other parameters in addition to the deployment area. For example, if a SIM has a limited plan (e.g., limited max data rate, no NR FR2, etc.), a different version of the database (taking the limitations into account) may be provided.

As an alternative to, or in parallel with, the downloaded updates 810, the UE may also update the database with observations made by the UE (830). For example, a UE may observe that, at a certain location, it has never utilized the maximum capabilities indicated in the downloaded/original database. The UE may store these observations (835) and periodically analyze the observations (840). Based on certain thresholds being met with respect to the observed network deployment, for example N days of reduced modem requirements in a particular network deployment, the UE may update the respective entry in the database (845). The UE may replace the entry, or keep the original entry as backup, e.g., to perform cross checks periodically. In another example, the UE may observe that at certain locations there are reduced capabilities at night, relative to during the day, and store that information accordingly. This behavior may be specifically monitored by the UE because, to save power, operators may switch off carriers/frequency in off-peak hours.

Similar to above, if the UE knows it has some further general limitations (e.g., SIM on a limited plan), it could update and cap the database entries to that limit. Alternatively, the UE could keep the database as-is, but cap the information queried when reading from the database.

### RRC Reconfiguration Event and Carrier Activation Event

A radio resource control (RRC) reconfiguration event is associated with an allowed setup delay for reconfiguration and carrier activation, which is defined in specification. A new carrier is added via a RRC connection message to the UE. The allowed setup delays for the different RRC procedures are defined in the 3GPP TS 38.331. A normal reconfiguration of parameters and the addition of SCells is distinguished, wherein procedures involving the addition of SCells allow a maximum delay of 16 ms. Assuming, for example, 6 ms are used for the processing, then a margin of 10 ms for the activation of additional carriers remains.

When the carrier is added it needs to be measured and reported by the UE. When the carriers are added/configured, they may be activated via a medium access control (MAC) control element (MAC-CE). The delay requirements are defined in 3GPP TS 38.133. For the MAC activation, typically an extra margin of 5 ms can be used as a setup delay.

When activated, the cellular modem has to handle PDCCH/PDSCH and Physical Uplink Shared Channel (PUSCH) on the newly activated carrier. Thus, if more modem parts than are currently powered are to be used for the additional carrier(s), the time duration allowed for powering on these parts is very small, e.g., approximately 15 ms are available to enable respective resources before a configured carrier can be used the first time.

The modem architecture may be designed so that the operations for a given carrier are performed at a single modem part, e.g., the secondary module of the modem described above. For example, if the secondary module is needed for a newly added carrier, the PDCCH handling and the PDSCH/PUSCH handling for the carrier may all be performed by the secondary module. This modem arrangement allows for a simplified hardware/software split, as well as wake-up procedure, for the secondary module. However, due to the small timeframe for activation of a new carrier, the secondary module would need to remain in standby mode during network deployments where the primary module can handle the currently configured carriers, but a new carrier, requiring the signal processing capacity of the secondary module, may be added at any time. Upon reception of an RRC message requesting new carriers, the secondary module can be fully activated and able to be used within the specified 15 ms. However, the secondary module may consume a significant amount of power in the standby state, despite a low probability that it is needed.

According to some exemplary embodiments, the modem architecture described above, comprising a primary module and a secondary module, may be used in the following manner. When the UE is deployed in a network arrangement requiring only the use of the primary module, e.g., a network deployment comprising 2CA, the UE may periodically check the database for cells/locations in the vicinity of the current UE location. If the UE determines that the secondary module may be used, for example, if the UE is currently approaching a cell wherein a greater maximum CA is configurable, then the UE may power up the secondary module in advance of reaching this area. The UE may detect that the cell is approaching based on increasing measurement results being obtained for the cell.

In combination with, in addition to, or instead of the operation discussed above, a modem architecture comprising further functional splits may be used by the UE. According to various exemplary embodiments described herein, the secondary module may be split further into functional entities covering certain aspects of the channel access. These different aspects/entities can then be chained together allowing each entity additional time for powering up and down. For example, the primary module may comprise a first part, and the secondary module may comprise a second part and a third part. Other modem architectures may also be used, where each of the “parts” is included in a separate “module.” However, as used herein, the various parts comprise different processing aspects for the modem that may be powered up and powered down independently from the other parts.

The activation of the new carrier may be split into a measurement part (small part) and a PDSCH/PDCCH decoding part (large part). Based on the RRC configuration, a first portion, e.g., a small measurement part, is enabled on the secondary module of the modem. In the background, a second portion, e.g., a large PDSCH part for processing the PDCCH as well as performing PDSCH decoding, is enabled. The second portion may have a longer boot up time than the first portion, based on the increased processing capabilities of the second portion.

Using the first portion (small part) of the secondary module, the UE can monitor the new carrier and transmit measurement reports for the new carrier, while the second portion (large part) is booted in parallel with or after the first portion.

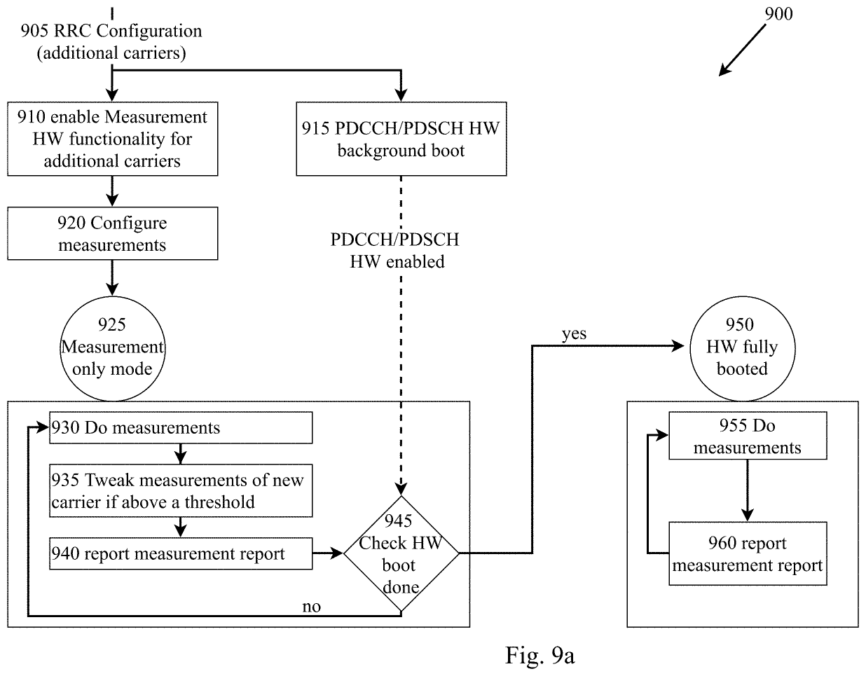

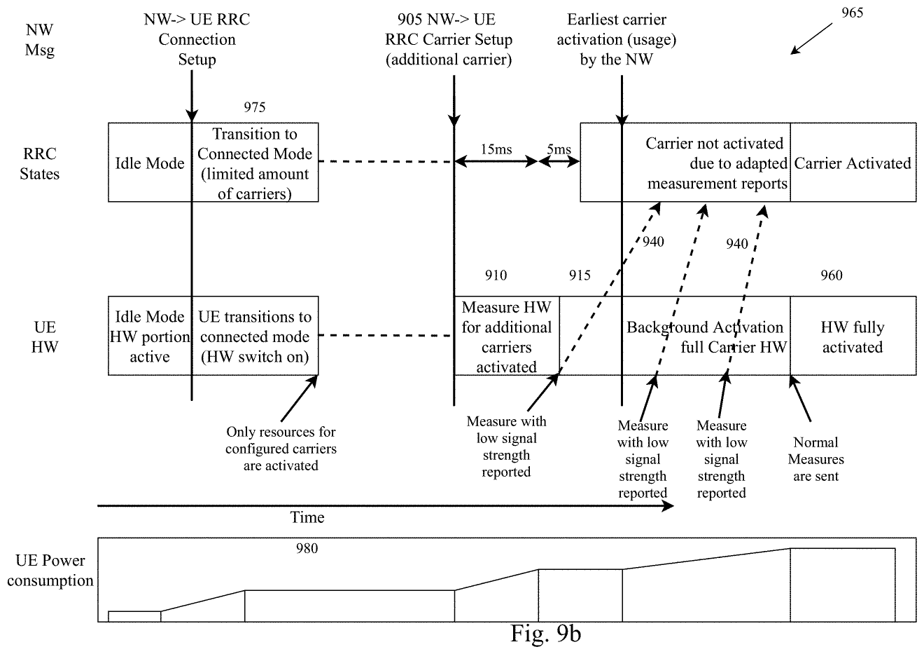

FIG. 9a shows a flowchart 900 for carrier activation handling using multi-part modem architecture according to various exemplary embodiments described herein. FIG. 9a will be described in combination with FIG. 9b. FIG. 9b shows an exemplary diagram 965 for carrier activation handling and an associated modem power consumption graph 970 as a function of time.

As shown in 975 in the diagram 965, the UE initially transitions from idle mode to connected mode with a limited set of carriers. Only the required carriers are activated, and a first part of the modem is powered. The other parts of the modem are completely powered down (e.g., not booted, power gated, no retention), as shown in 980 of the power consumption graph, allowing for a reduced power consumption until the carriers are actually used.

In 905, as shown in FIGS. 9a and 9b, upon reception of a new carrier configuration, at first only the small measurement portion is activated (910). This allows the handling of the measurements for the additional carriers.

In 915, after (or in parallel with) the activation of the measurement part in 910, the longer booting and initialization of the additional carrier hardware is started in the background. The deadline for the carrier activation after 20 ms, discussed above, may not be met, as the hardware for the additional carriers is switched off completely and requires greater than 20 ms for booting up. Thus, to completely power the additional hardware, results in durations on the order of 100 ms.

During the booting of the additional hardware, the UE enters a measurement-only mode 925 in which measurements are performed (930) and one or more measurement reports are transmitted (940). However, to avoid the carrier activation by the network until the additional hardware is fully booted, the measurement report may be adapted to be below a configured threshold (935). This threshold may be low enough for the network to not consider this carrier for actual data transmission. For example, in 935, the actual measurements may be adjusted so that the network will not transmit data in reliance on the measurement report. In case the measured values do not exceed the threshold, the reports will be sent to the network unchanged, assuming that the threshold is sufficiently small that the cell will not be activated by the network.

In other exemplary embodiments, depending on the network implementation, the measurement reporting may also be muted. This may be used in scenarios where the network does not use a carrier until it receives a measurement report, after configuration.

In 945, the processor/modem checks whether the additional hardware (PDSCH part) is fully booted. After the final boot of the hardware (950), measurements are performed (955) and actual measurements are included in the report (960), e.g., normal measurement reporting is resumed. Based on the measurements, the network may use the carrier.

The procedure described above ensures that the PDSCH and measurement handling can be decoupled, and a longer duration for the PDSCH activation may be used. Thus, an increase from 15 ms to a duration on the order of hundreds of milliseconds is possible and still within an acceptable duration in view of the power save measures.

A similar handling as for the carrier activation can be done for multiple MIMO layers and/or multiple antennas. For example, the UE reports the rank indicator to the network, e.g., the recommended number of layers to be used. Typically, the network follows the recommendation of the UE.

The following approach may be used for the activation of more MIMO layers than are currently activated. First, using a small part of the modem, the UE monitors the channel and, based on the result creates a rank recommendation. The UE averages the results and, after a certain time and a configured threshold, the UE determines the rank is higher than the small part can handle. At this time, a large part of the modem is activated to handle the increased rank. Until the large part is fully booted, the measurement reports are adapted to report the lower MIMO rank. Once the large part of the modem is booted, the actual rank is reported and the additional layers can be served. A similar process may be used with regard to the number of antennas to be used.

### Examples

In a first example a processor of a user equipment (UE) is configured to perform operations comprising powering on a primary module of a cellular modem to perform signal processing operations for the UE, the primary module having first signal processing capabilities, detecting an occurrence of an event, wherein the event indicates a change in network operations to be performed by the UE, determining event information indicating whether the change in network operations may use more signal processing capabilities than the primary module is able to perform, determining, based on the event information, a power state to be used for a secondary module of the cellular modem, wherein secondary module has second signal processing capabilities and is configured to perform further signal processing operations for the UE, wherein the power state comprises a fully powered off state, a standby state, or a fully powered on state and changing a current power state for the secondary module when the determined power state is different from the current power state.

In a second example, the processor of the first example, wherein the operations further comprise checking the event information against a database, wherein the database indicates maximum expected capabilities of the network operations and determining whether the first signal processing capabilities of the primary module are sufficient to perform the maximum expected capabilities of the network operations.

In a third example, the processor of the second example, wherein the event comprises a first subscriber identification module (SIM) activation for a first public land mobile network (PLMN).

In a fourth example, the processor of the third example, wherein the first SIM activation is a switch from a second SIM for a second PLMN to the first SIM.

In a fifth example, the processor of the second example, wherein the event comprises a tracking area (TA) change from a first TA for the PLMN to a second TA for the PLMN.

In a sixth example, the processor of the second example, wherein the event comprises a cell change from a first cell within a tracking area (TA) to a second cell within the TA.

In a seventh example, the processor of the second example, wherein the database is stored to the UE by an original equipment manufacturer (OEM).

In an eighth example, the processor of the seventh example, wherein the database is updated by a download provided by the OEM or an operator.

In a ninth example, the processor of the second example, wherein the database is updated based on observations made by the UE of actual network operations in a network deployment relative to the maximum expected capabilities of the network operations in the network deployment.

In a tenth example, the processor of the second example, wherein the event comprises an approaching cell in a mobility scenario, wherein the maximum expected capabilities of the network operations using the approaching cell are different from the maximum expected capabilities of the network operations of a current cell.

In an eleventh example a user equipment (UE) comprises a transceiver configured to communicate with a network and a processor communicatively coupled to the transceiver and configured to perform operations comprising powering on a primary module of a cellular modem to perform signal processing operations for the UE, the primary module having first signal processing capabilities, detecting an occurrence of an event, wherein the event indicates a change in network operations to be performed by the UE, determining event information indicating whether the change in network operations may use more signal processing capabilities than the primary module is able to perform, determining, based on the event information, a power state to be used for a secondary module of the cellular modem, wherein secondary module has second signal processing capabilities and is configured to perform further signal processing operations for the UE, wherein the power state comprises a fully powered off state, a standby state, or a fully powered on state and changing a current power state for the secondary module when the determined power state is different from the current power state.

In a twelfth example a user equipment (UE) comprises a transceiver configured to communicate with a network and a processor communicatively coupled to the transceiver and configured to perform operations comprising powering on a first part of a cellular modem to perform signal processing operations for the UE, the first part having first signal processing capabilities, detecting an occurrence of an event, wherein the event indicates an increase in total network operations to be performed by the UE, powering on a second part of the cellular modem to perform channel measurement functions, the second part having second signal processing capabilities, wherein the first and second signal processing capabilities of the first and second parts are insufficient for performing the increased total network operations to be performed by the UE, initiating a powering-on of a third part of the cellular modem having third signal processing capabilities, wherein the first, second and third signal processing capabilities of the first, second and third parts are sufficient for performing the increased total network operations to be performed by the UE, wherein the second part performs the channel measurement functions during the powering-on of the third part.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to perform operations comprising:
powering on a primary module of a cellular modem to perform signal processing operations for the UE, the primary module having first signal processing capabilities;
detecting an occurrence of an event, wherein the event indicates a change in network operations to be performed by the UE;
determining event information indicating whether the change in network operations may use more signal processing capabilities than the primary module is able to perform;
determining, based on the event information, a power state to be used for a secondary module of the cellular modem, wherein secondary module has second signal processing capabilities and is configured to perform further signal processing operations for the UE, wherein the power state comprises a fully powered off state, a standby state, or a fully powered on state; and
changing a current power state for the secondary module when the determined power state is different from the current power state.

2. The processor of claim 1, wherein the operations further comprise:
checking the event information against a database, wherein the database indicates maximum expected capabilities of the network operations; and
determining whether the first signal processing capabilities of the primary module are sufficient to perform the maximum expected capabilities of the network operations.

3. The processor of claim 2, wherein the operations further comprise:
changing the power state for the secondary module to the fully powered off state when the first signal processing capabilities of the primary module are sufficient to perform the maximum expected capabilities of the network operations.

4. The processor of claim 2, wherein the operations further comprise:
changing the power state for the secondary module to the standby state when the first signal processing capabilities of the primary module are sufficient to perform currently configured capabilities of the network operations but are insufficient to perform the maximum expected capabilities of the network operations.

5. The processor of claim 2, wherein the operations further comprise:
changing the power state for the secondary module to the fully powered on state when the first signal processing capabilities of the primary module are insufficient to perform currently configured capabilities of the network operations.

6. The processor of claim 2, wherein the event information comprises a public land mobile network (PLMN) identifier (ID) for a PLMN providing the change in network operations, the operations further comprising:
checking the PLMN ID against the database to determine the maximum expected capabilities of the PLMN.

7. The processor of claim 6, wherein the event information further comprises a tracking area (TA) identifier (TAI) for a TA of a selected cell deployed by the PLMN.

8. The processor of claim 7, wherein the event information further comprises a cell ID for the selected cell.

9. The processor of claim 2, wherein the maximum expected capabilities of the network operations comprises a maximum number of carriers, a maximum bandwidth, a maximum multiple-input multiple-output (MIMO) arrangement, a maximum number of MIMO layers, or a maximum number of antennas for a network deployment.

10. The processor of claim 9, wherein the UE checks the maximum expected capabilities of the network operations against the first signal processing capabilities of the primary module to determine whether the second signal processing capabilities of the secondary module are required.

11. A processor of a user equipment (UE) configured to perform operations comprising:
powering on a first part of a cellular modem to perform signal processing operations for the UE, the first part having first signal processing capabilities;
detecting an occurrence of an event, wherein the event indicates an increase in total network operations to be performed by the UE;
powering on a second part of the cellular modem to perform channel measurement functions, the second part having second signal processing capabilities, wherein the first and second signal processing capabilities of the first and second parts are insufficient for performing the increased total network operations to be performed by the UE; and
initiating a powering-on of a third part of the cellular modem having third signal processing capabilities, wherein the first, second and third signal processing capabilities of the first, second and third parts are sufficient for performing the increased total network operations to be performed by the UE,
wherein the second part performs the channel measurement functions during the powering-on of the third part.

12. The processor of claim 11, wherein the event comprises a radio resource control (RRC) reconfiguration in which one or more additional carriers are configured.

13. The processor of claim 12, wherein the channel measurement functions performed by the second part include channel measurements and measurement reporting.

14. The processor of claim 13, wherein the channel measurement functions are performed by the second part while the powering-on of the third part has been initiated but is not yet complete.

15. The processor of claim 14, wherein the operations further comprise:
comparing actual channel measurements to a threshold value;
when the actual channel measurements exceed the threshold value, reducing the channel measurements in the measurement reporting to a value below the threshold value; and
when the actual channel measurements do not exceed the threshold value, reporting the actual channel measurements.

16. The processor of claim 15, wherein the operations further comprise:
when the powering-on of the third part is complete, performing the channel measurements and the measurement reporting using unmodified channel measurement values.

17. The processor of claim 16, wherein the third part is used to decode a physical downlink control channel (PDCCH) and a physical downlink shared channel (PDSCH) for the one or more additional carriers.

18. The processor of claim 11, wherein measurement reporting is muted until the powering-on of the third part is complete.

19. The processor of claim 11, wherein the event comprises an increased multiple-input multiple-output (MIMO) rank, measurement reports are adapted to report a lower MIMO rank until the powering-on of the third part is complete.

20. The processor of claim 11, wherein the powering-on of the second part and the powering-on of the third part are performed in parallel.
